(19) United States
(12) Patent Application Publication
(10) Pub. No.: US 2025/0050928 A1
(43) Pub. Date: Feb. 13, 2025

(54) Snow Sports Equipment Cart Device

(71) Applicant: Shelley Kay Meyer, Lucas, OH (US)

(72) Inventor: Shelley Kay Meyer, Lucas, OH (US)

(21) Appl. No.: 18/800,697

(22) Filed: Aug. 12, 2024

Related U.S. Application Data
(60) Provisional application No. 63/518,697, filed on Aug. 10, 2023.

(51) Int. Cl. B62B 3/10; B62B 3/02; B62B 3/04; B62B 5/06

(52) U.S. Cl. CPC B62B 3/10; B62B 3/02; B62B 3/04; B62B 5/067; B62B 2202/401

(57) ABSTRACT

A snow sports equipment cart device is provided. The device is comprised of a collapsible body comprised of an interior space. The body may be comprised of at least one receiving area designed to receive skis, snowboards, ski poles, etc. The interior space may also be comprised of an insert positioned within the interior space, wherein the insert is comprised of additional receiving areas. As a result, the receiving areas of the rack and the insert secure skis, snowboards, and ski poles while the device is in motion.

### CROSS-REFERENCE TO RELATED APPLICATION

The present application claims priority to, and the benefit of, U.S. Provisional Application No. 63/518,697, which was filed on Aug. 10, 2023, and is incorporated herein by reference in its entirety.

### FIELD OF THE INVENTION

The present invention relates generally to the field of carts and wagons. More specifically, the present invention relates to a snow sports equipment cart device that has specific receiving areas that are designed to secure skis, snowboards, ski poles, etc., and provide further storage area in a pullable cart. Accordingly, the present disclosure makes specific reference thereto. Nonetheless, it is to be appreciated that aspects of the present invention are also equally applicable to other like applications, devices, and methods of manufacture.

### BACKGROUND

Skiing and snowboarding are time-honored winter activities enjoyed by countless individuals around the world. For many, these sports are not just pastimes; they represent a deep connection to nature, an adrenaline rush, or even a family tradition that gets revisited every winter season. Yet, as with many endeavors, participating in these winter sports comes with its own set of practical hurdles. One of the most commonly encountered challenges is the efficient transportation of necessary equipment.

When participants reach their destination, which is often a sprawling ski or snowboard resort nestled in the mountains, they are presented with the task of transporting their gear from often distant parking areas to the main lodge or starting point of the slopes. This is not just about moving a pair of skis or a snowboard; it is about safely and efficiently carrying an ensemble of equipment that includes weighty boots, and for skiers, poles that can be long and unwieldy.

The process of moving this equipment is rarely straightforward. Beyond the sheer physical effort, there is the task of navigating through busy resort areas filled with other enthusiasts, all while on potentially uneven, snowy, or icy terrains. These initial logistical obstacles can, at times, be a dampener on the overall enthusiasm and anticipation of hitting the slopes. Such experiences underscore the need for innovation and better strategies to make the process of equipment transportation smoother and more enjoyable for all involved.

Therefore, there exists a long-felt need in the art for a device for transporting skiing and snowboard equipment. There also exists a long-felt need in the art for a snow sports equipment cart device. More specifically, there exists a long-felt need in the art for a snow sports equipment cart device that can be used to transport skiing and snowboard equipment. Further, there exists a long-felt need in the art for a snow sports equipment cart device that can be used to transport skiing and snowboard equipment in a secure manner. In addition, there exists a long-felt need in the art for a snow sports equipment cart device that can be used to transport skiing and snowboard equipment in a secure manner wherein the device can be easily stored when not in use.

The subject matter disclosed and claimed herein, in one embodiment thereof, comprises a snow sports equipment cart device. The device is comprised of a collapsible body comprised of an interior space. The body may be comprised of a folding rack comprised of at least one receiving area designed to receive skis, snowboards, ski poles, etc. The interior space may also be comprised of an insert positioned within the interior space, wherein the insert is comprised of additional receiving areas. As a result, the receiving areas of the rack and the insert secure skis, snowboards, and ski poles while the device is in motion. The interior space provides further storage areas for various other skiing and snowboard-related gear, supplies, etc.

In this manner, the snow sports equipment cart device of the present invention accomplishes all the foregoing objectives and provides a device that can be used to transport skiing and snowboard equipment. Further, the device does so in a secure manner. Further, the device can be easily stored when not in use.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a snow sports equipment cart device. The device is comprised of a body that can be used to transport a plurality of snow sports-related items such as, but not limited to, skis, ski poles, snowboards, boots, etc., in an interior space of the body.

In one embodiment, the body is comprised of a telescopic frame to allow the device to collapse. The frame is comprised of at least one sidewall. The sidewall may be made from a fabric material or a rigid material such as, but not limited to, plastic. In one embodiment, the body is comprised of at least one wheel of any type known in the art.

The device can be pulled via at least one handle. In one embodiment, the handle is comprised of a telescopic handle that can increase or decrease in size. In another embodiment, the handle is comprised of at least one hinge that allows the handle to fold while the device is stored.

In one embodiment, the body is comprised of at least one rack. The rack may be telescopic, such that it can increase or decrease in size to accommodate items of various lengths. The rack may be comprised of at least one hinge that allows the rack to fold while the device is stored. The rack is preferably comprised of at least one receiving area configured to receive at least one item such as, but not limited to, a snowboard, a ski, a ski pole, etc.

The interior space may also be comprised of at least one insert that may be comprised of at least one receiving structure that is preferably configured to receive at least one item such as, but not limited to, a snowboard, a ski, a ski pole, etc. In this manner, the receiving structures receive each end of the item to prevent movement of the item.

The present invention is also comprised of a method of using the device. First, a device is provided comprised of a body comprised of an interior space, at least one handle, and at least one rack comprised of at least one receiving area. Then, the handle can be locked in an unfolded position. Next, the rack can be unfolded and locked in an unfolded position. Then, at least one item can be placed in the interior space. In one embodiment, at least one item such as, but not limited to, a ski, a ski pole, a snowboard, etc., can be placed within at least one receiving area of the rack and at least one receiving structure of an insert within the interior space.

Accordingly, the snow sports equipment cart device of the present invention is particularly advantageous as it provides a device that can be used to transport skiing and snowboard equipment. Further, the device does so in a secure manner. Further, the device can be easily stored when not in use. In this manner, the snow sports equipment cart device provides a solution for easily transporting skiing and snowboard equipment.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a snow sports equipment cart device of the present invention while unfolded in accordance with the disclosed architecture;

FIG. 2 illustrates a perspective view of one potential embodiment of a snow sports equipment cart device of the present invention while unfolded and while carrying items in accordance with the disclosed architecture;

FIG. 3 illustrates a perspective view of one potential embodiment of a snow sports equipment cart device of the present invention while folded in accordance with the disclosed architecture; and

FIG. 4 illustrates a flowchart of a method of using one potential embodiment of a snow sports equipment cart device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for transporting skiing and snowboard equipment. There also exists a long-felt need in the art for a snow sports equipment cart device. More specifically, there exists a long-felt need in the art for a snow sports equipment cart device that can be used to transport skiing and snowboard equipment. Further, there exists a long-felt need in the art for a snow sports equipment cart device that can be used to transport skiing and snowboard equipment in a secure manner. In addition, there exists a long-felt need in the art for a snow sports equipment cart device that can be used to transport skiing and snowboard equipment in a secure manner, wherein the device can be easily stored when not in use.

The present invention, in one exemplary embodiment, is comprised of a snow sports equipment cart device comprised of a body that can be used to transport a plurality of snow sports-related items such as, but not limited to, skis, ski poles, snowboards, boots, etc., in an interior space of the body. In one embodiment, the body is comprised of a telescopic frame to allow the device to collapse. The frame is comprised of at least one sidewall. The sidewall may be made from a fabric material or a rigid material such as, but not limited to, plastic. In one embodiment, the body is comprised of at least one wheel of any type known in the art.

The device can be pulled via at least one handle. In one embodiment, the handle is comprised of a telescopic handle that can increase or decrease in size. In another embodiment, the handle is comprised of at least one hinge that allows the handle to fold while the device is stored.

In one embodiment, the body is comprised of at least one rack that may be telescopic, such that it can increase or decrease in size to accommodate items of various lengths. The rack may be comprised of at least one hinge that allows the rack to fold while the device is stored. The rack is preferably comprised of at least one receiving area. The area is configured to receive at least one item such as, but not limited to, a snowboard, a ski, a ski pole, etc.

The interior space may also be comprised of at least one insert that may be comprised of at least one receiving structure that is preferably configured to receive at least one item such as, but not limited to, a snowboard, a ski, a ski pole, etc. In this manner, the receiving structures receive each end of the item in order to prevent movement of the item.

The present invention is also comprised of a method of using the device. First, a device is provided comprised of a body comprised of an interior space, at least one handle, and at least one rack comprised of at least one receiving area. Then, the handle can be locked in an unfolded position. Next, the rack can be unfolded and locked in an unfolded position. Then, at least one item can be placed in the interior space. In one embodiment, at least one item such as, but not limited to, a ski, a ski pole, a snowboard, etc., can be placed within at least one receiving area of the rack and at least one receiving structure of an insert within the interior space.

Accordingly, the snow sports equipment cart device of the present invention is particularly advantageous as it provides a device that can be used to transport skiing and snowboard equipment. Further, the device does so in a secure manner. Further, the device can be easily stored when not in use. In this manner, the snow sports equipment cart device provides a solution for easily transporting skiing and snowboard equipment.

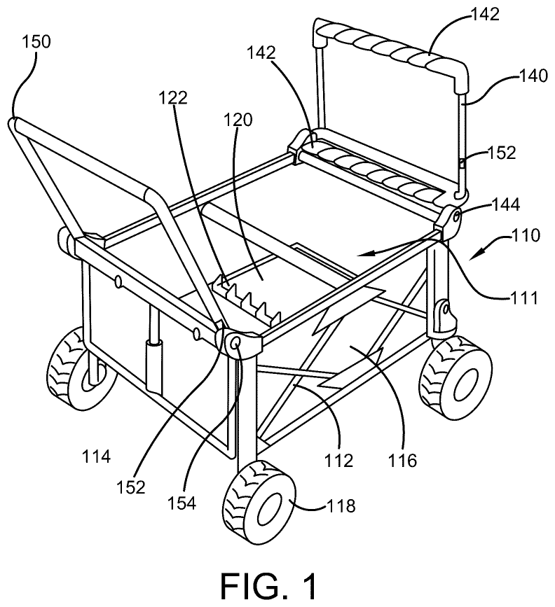

Referring initially to the drawings, FIG. 1 illustrates a perspective view of one potential embodiment of a snow sports equipment cart device 100 of the present invention while unfolded in accordance with the disclosed architecture. The device 100 is comprised of a body 110 that can be used to transport a plurality of snow sports-related items 10 such as, but not limited to, skis, ski poles, snowboards, boots, etc., in an interior space 111 of the body 110.

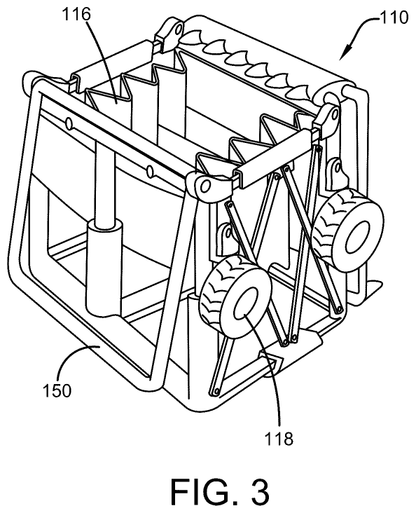

The device 100 is comprised of a body 110. The body 110 is preferably generally rectangular but may be any shape. The body 110 is comprised of a frame 112. The frame 112 may be made from any material. The frame 112 may be telescopic in one embodiment to allow the device 100 to collapse, as seen in FIG. 3. The frame 112 may be comprised of at least one fastener 114 such as, but not limited to, a hook, a clip, a clamp, etc., that allows a user to hang or secure other items 10 to the frame 112.

The frame 112 is comprised of at least one sidewall 116. The sidewall 116 may be made from a fabric material or a rigid material such as, but not limited to, plastic. In one embodiment, the body 110 is comprised of at least one wheel 118 of any type known in the art. In another embodiment, the wheel 118 is in the form of a ski to aid the device 100 in moving over snow.

The device 100 can be pulled via at least one handle 150. In one embodiment, the handle 150 is comprised of a telescopic handle that can increase or decrease in size. In another embodiment, the handle 150 is comprised of at least one hinge 154 that allows the handle 150 to fold while the device 100 is stored. The hinge 154 may be any type but is preferably a locking hinge that allows the handle 150 to be locked in a folded or unfolded position. The length of the handle 150 may also be secured via a locking member 152 of any type known in the art.

In one embodiment, the body 110 is comprised of at least one rack 140. The rack 140 may be telescopic, such that it can increase or decrease in size to accommodate items 10 of various lengths. The rack 140 may be comprised of at least one hinge 144 that allows the rack 140 to fold while the device 100 is stored. The hinge 144 may be any type but is preferably a locking hinge that allows the rack 140 to be locked in a folded or unfolded position. The length of the rack 140 may also be secured via a locking member 152 of any type known in the art.

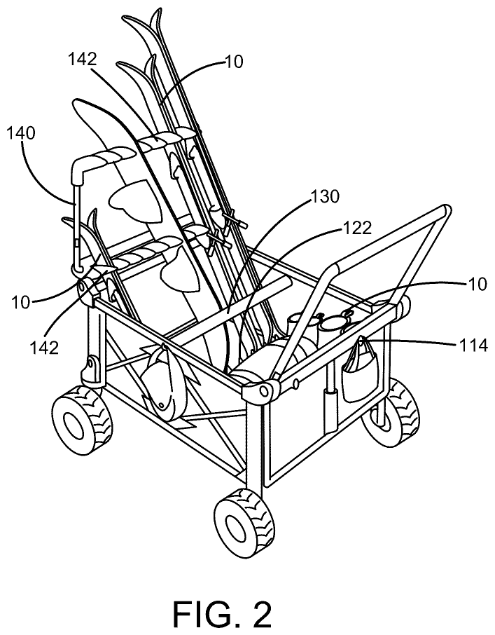

The rack 140 is preferably comprised of at least one receiving area 142. The receiving area 142 is preferably configured to receive at least one item 10 such as, but not limited to, a snowboard, a ski, a ski pole, etc., as shown in FIG. 2. The interior space 111 may also be comprised of at least one insert 120 that may be removable or non-removable. The insert 120 may also be comprised of at least one receiving structure 122 that is preferably configured to receive at least one item 10 such as, but not limited to, a snowboard, a ski, a ski pole, etc. In this manner, the receiving structures 122,142 receive each end of the item 10 in order to prevent movement of the item. The interior space 111 may be divided via at least one internal divider 130. The divider 130 separates the interior space 111 to allow a user to store various items 10 on the side of the space 11 with the rack 140 such as, but not limited to, snowboards, skis, ski poles, etc., and wherein the other side of the space 111 can be used to store items 10 such as, but not limited to, boots, clothing, bags, food, water, etc.

All components of the device 100 are preferably made from a weatherproof material that includes, but is not limited to, aluminum, rubber, nylon, etc.

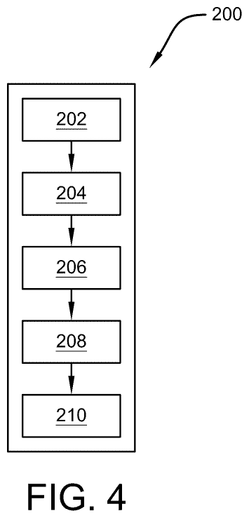

The present invention is also comprised of a method of using 200 the device 100, as seen in FIG. 4. First, a device 100 is provided comprised of a body 110 comprised of an interior space 111, at least one handle 150, and at least one rack 140 comprised of at least one receiving area 142 [Step 202]. Then, the handle 150 can be locked in an unfolded position [Step 204]. Next, the rack 140 can be unfolded and locked in an unfolded position [Step 206]. Then, at least one item 10 can be placed in the interior space 110 [Step 208]. In one embodiment, at least one item 10 such as, but not limited to, a ski, a ski pole, a snowboard, etc., can be placed within at least one receiving area 142 of the rack 140 and at least one receiving structure 122 of an insert 120 within the interior space 111 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “snow sports equipment cart device” and “device” are interchangeable and refer to the snow sports equipment cart device 100 of the present invention.

Notwithstanding the foregoing, the snow sports equipment cart device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the snow sports equipment cart device 100 as shown in the FIGS. are for illustrative purposes only, and that many other sizes and shapes of the snow sports equipment cart device 100 are well within the scope of the present disclosure. Although the dimensions of the snow sports equipment cart device 100 are important design parameters for user convenience, the snow sports equipment cart device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A snow sports equipment cart device comprising:
a body comprised of an interior space, a frame, and a sidewall;
a rack comprised of a receiving area;
a handle; and
a wheel.

2. The snow sports equipment cart device of claim 1, wherein the frame is comprised of a collapsible frame.

3. The snow sports equipment cart device of claim 1, wherein the frame is comprised of a fastener.

4. The snow sports equipment cart device of claim 3, wherein the fastener is comprised of a hook, a clip, or a clamp.

5. The snow sports equipment cart device of claim 1, wherein the sidewall is comprised of a fabric material.

6. A snow sports equipment cart device comprising:
a body comprised of an interior space, a frame, and a sidewall;
a rack comprised of a first receiving area;
an insert comprised of a second receiving area; and
a handle.

7. The snow sports equipment cart device of claim 6 further comprised of a wheel.

8. The snow sports equipment cart device of claim 6 further comprised of a ski.

9. The snow sports equipment cart device of claim 6, wherein the handle is comprised of a first hinge.

10. The snow sports equipment cart device of claim 9, wherein the handle is comprised of a telescopic handle.

11. The snow sports equipment cart device of claim 6, wherein the rack is comprised of a second hinge.

12. The snow sports equipment cart device of claim 6, wherein the rack is comprised of a telescoping rack.

13. The snow sports equipment cart device of claim 6, wherein the interior space is comprised of an internal divider.

14. The snow sports equipment cart device of claim 6, wherein the sidewall is comprised of a rigid material.

15. A method of using a snow sports equipment cart device, the method comprising the following steps:
providing a snow sports equipment cart device comprised of body comprised of an interior space, a handle, and a rack comprised of a first receiving area;
locking the handle in an unfolded position;
locking the rack in an unfolded position; and
placing an item within the first receiving area.

16. The method of using a snow sports equipment cart device of claim 15 further comprised of an insert that can be placed within the interior space.

17. The method of using a snow sports equipment cart device of claim 16, wherein the insert is comprised of a second receiving area.

18. The method of using a snow sports equipment cart device of claim 15, wherein the item is comprised of a ski, a snowboard, or a ski pole.

19. The method of using a snow sports equipment cart device of claim 17 further comprised of a step of placing the item within the second receiving area.

20. The method of using a snow sports equipment cart device of claim 15, wherein the frame is comprised of a collapsible frame.
